(19) United States
(12) Patent Application Publication
(10) Pub. No.: US 2018/0138476 A1
(43) Pub. Date: May 17, 2018

(54) BATTERY MODULE

(71) Applicant: TOYOTA JIDOSHA KABUSHIKI KAISHA, Toyota-shi (JP)

(72) Inventors: Nobuyuki YAMAZAKI, Okazaki-shi (JP); Yukinari TANABE, Nagoya-shi (JP)

(73) Assignee: TOYOTA JIDOSHA KABUSHIKI KAISHA, Toyota-shi (JP)

(21) Appl. No.: 15/809,112

(22) Filed: Nov. 10, 2017

(30) Foreign Application Priority Data
Nov. 15, 2016 (JP) 2016-222568

(51) Int. Cl. H01M 2/10; H01M 10/04

(52) U.S. Cl. CPC H01M 2/1077; H01M 2220/20; H01M 10/0422

(57) ABSTRACT

A battery module includes a plurality of column-shaped batteries 12, a battery holder 14 having a plurality of retention holes 15 and being configured to hold the plurality of column-shaped batteries 12 in an upright position, and an adhesive placed between an inner circumferential surface of each of the retention holes 15 and an outer circumferential surface of a corresponding one of the column-shaped batteries 12. At least one of the inner circumferential surface of the retention hole 15 and the outer circumferential surface of the column-shaped battery 12 has an uneven surface 70 having a surface height varying in accordance with at least the position in the axial direction.

### CROSS REFERENCE TO RELATED APPLICATION

The entire disclosure of Japanese Patent Application No. 2016-222568 filed on Nov. 15, 2016 including the specification, claims, drawings, and abstract is incorporated herein by reference in its entirety.

### TECHNICAL FIELD

This specification discloses a battery module including a plurality of column-shaped batteries and a battery holder, the battery holder being configured to hold the plurality of column-shaped batteries in an upright position.

### BACKGROUND

Battery modules composed of a plurality of batteries that are connected either in parallel or in series have been known. Some of such battery modules include a plurality of column-shaped batteries, and a battery holder configured to hold the plurality of column-shaped batteries in an upright position. The battery holder has retention holes in which the respective batteries are inserted. To prevent the batteries from dropping off from the retention holes, spaces between the batteries and the retention holes are typically filled with an adhesive.

JP 2006-099997 A discloses such a battery module (battery pack). Specifically, the battery pack (battery module) disclosed in JP 2006-099997 A includes circular column-shaped batteries, and holders in which ends of the batteries are fitted. The holders have cylindrical holes (retention holes) for holding the batteries, and the inner circumferential surfaces of the cylindrical holes have a plurality of axially extending ribs that are spaced apart from each other in the circumferential direction. Further, an adhesive is applied to spaces between the ribs. The batteries are fixed to the holders by this adhesive.

However, in the structure disclosed in JP 2006-099997 A, because the ribs extend only in the axial direction, the adhesive that is yet to be cured may drip from the ends of the cylindrical holes to the outside. Further, because the ribs extend in the axial direction, the flow of the adhesive in the circumferential direction is hindered. As a result, the amount of the applied adhesive tends to be non-uniform in the circumferential direction. Although it is true that removing the ribs will allow the adhesive to flow in the circumferential direction, even in this case, the dripping of the adhesive cannot be prevented. In other words, the conventional technique may suffer from a shortage of the adhesive between the column-shaped batteries and the battery holders caused by, for example, the dripping of the adhesive, which may weaken the fixing of the column-shaped batteries and the battery holders to each other.

To address this situation, a battery module having column-shaped batteries more firmly and securely fixed to a battery holder is disclosed herein.

### SUMMARY

A battery module disclosed herein includes a plurality of column-shaped batteries; a battery holder having a plurality of retention holes, each housing a coverage zone that is a portion of a corresponding one of the plurality of column-shaped batteries, the portion having a width in the axial direction of the column-shaped battery, the battery holder being configured to hold the plurality of column-shaped batteries in an upright position; and an adhesive placed between an inner circumferential surface of each of the retention holes and an outer circumferential surface of a corresponding one of the coverage zones for fixing the column-shaped battery in the retention hole. At least one of the inner circumferential surface of the retention hole and the outer circumferential surface of the coverage zone has an uneven surface. The uneven surface includes at least one of a groove that extends in a direction that is not parallel to the axial direction, a rib that extends in a direction that is not parallel to the axial direction, and a group of projections and depressions consisting of projections and depressions that are dispersed uniformly on at least one of the inner circumferential surface of the retention hole and the outer circumferential surface of the coverage zone.

As there is formed an uneven surface including at least one of a groove that extends in a direction that is not parallel to the axial direction, a rib that extends in a direction that is not parallel to the axial direction, and a group of projections and depressions consisting of projections and depressions that are dispersed uniformly on at least one of the inner circumferential surface of the retention hole and the outer circumferential surface of the coverage zone, even if a fit clearance between the inner circumferential surface of the retention hole and the outer circumferential surface of the coverage zone is reduced such that the dripping of the adhesive can be prevented, the adhesive spreads easily by a capillary phenomenon. As a result, as both the prevention of the dripping of the adhesive and the uniform dispersion of the adhesive can be achieved, the column-shaped battery can be more firmly and securely fixed to the battery holder.

The uneven surface may include a groove or a rib that extends in the circumferential direction.

By configuring a battery module in this manner, as the adhesive reliably spreads in the circumferential direction, the adhesive can be more reliably dispersed uniformly, and, in turn, the column-shaped battery can be more firmly and securely fixed to the battery holder.

The column-shaped battery may include a column-shaped battery body and an insulator that covers the outer periphery of the battery body, the insulator being composed of an insulating material. The uneven surface may include at least one of a groove, a cut, or a wrinkle formed only in a portion of the insulator corresponding to the coverage zone.

By configuring a battery module in this manner, as both the prevention of the dripping of the adhesive and the uniform dispersion of the adhesive can be achieved, the column-shaped battery can be more firmly and securely fixed to the battery holder. Further, the expansion and shrinkage of an insulating tube that occur due to changes in temperature can be caused to selectively occur prominently in a portion corresponding to the coverage zone. As a result, deterioration (cracks) in the insulating tube caused by the expansion and shrinkage will tend to occur in the portion corresponding to the coverage zone, and it is unlikely that deterioration (cracks) will occur in the remaining portions. As the coverage zone is surrounded by the adhesive (an insulator), even if cracks are produced in the insulating tube, the insulation of the column-shaped battery can be ensured.

Further, the battery holder may be entirely coated with an insulating material.

By configuring a battery module in this manner, when cracks are produced in the insulating tube due to the expansion and shrinkage in the portion corresponding to the coverage zone, as the cracked portions can be surrounded not only by the adhesive but also by the battery holder (the inner circumferential surface of the retention hole) coated with an insulating material, the insulation of the column-shaped battery can be ensured more reliably.

As an uneven surface including at least one of a groove that extends in a direction that is not parallel to the axial direction, a rib that extends in a direction that is not parallel to the axial direction, and a group of projections and depressions consisting of projections and depressions that are dispersed uniformly on at least one of the inner circumferential surface of the retention hole and the outer circumferential surface of the coverage zone is formed, even if a fit clearance between the inner circumferential surface of the retention hole and the outer circumferential surface of the coverage zone is reduced such that the dripping of the adhesive can be prevented, the adhesive spreads easily by a capillary phenomenon. As a result, as both the prevention of the dripping of the adhesive and the uniform dispersion of the adhesive can be achieved, the column-shaped battery can be more firmly and securely fixed to the battery holder.

### BRIEF DESCRIPTION OF DRAWINGS

Embodiments of the present disclosure will be described based on the following figures, wherein:

FIG. 1 is an exploded perspective view of a battery module according to an embodiment;

FIG. 2 is a cross-sectional view of the battery module;

FIG. 3 illustrates a structure of a unit battery;

FIG. 4 illustrates an example of an uneven surface;

FIG. 5 illustrates another example of an uneven surface;

FIG. 6 illustrates another example of an uneven surface;

FIG. 7 illustrates another example of an uneven surface;

FIG. 8 illustrates a conventional manner in which a unit battery is bonded;

FIG. 9 is a cross-sectional view taken along line A-A in FIG. 8; and

FIG. 10 illustrates a state in which cracks are produced in a unit battery in a conventional technique.

### DESCRIPTION OF EMBODIMENTS

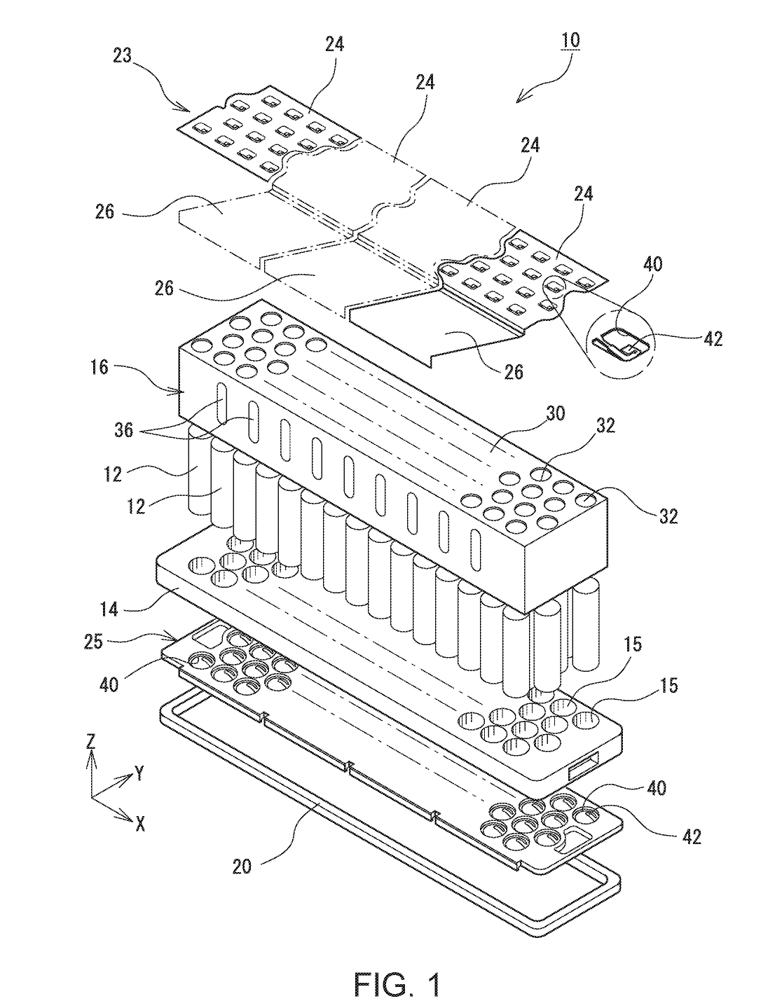

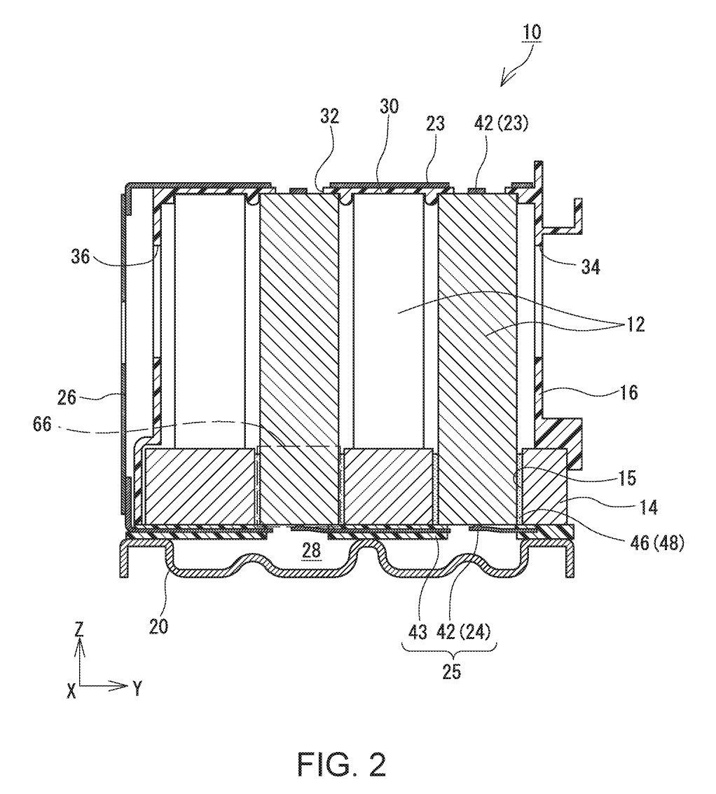

A battery module 10 according to an embodiment will be described below with reference to the accompanying drawings. FIG. 1 is an exploded perspective view of the battery module 10 according to the embodiment. FIG. 2 is a YZ plane cross-sectional view of the battery module 10. In the following description, the longitudinal direction of the battery module 10 is referred to as “X direction,” the axial direction of a unit battery 12 is referred to as “Z direction,” and the direction perpendicular to the X direction and the Z direction is referred to as “Y direction.”

The battery module 10 includes a plurality of circular column-shaped unit batteries 12. A unit battery 12 is a chargeable and dischargeable secondary battery, such as a nickel-metal hydride battery or a lithium ion battery housed in a circular column-shaped case. A negative electrode terminal and a positive electrode terminal, which serve as electrodes of the unit battery 12, are provided on respective ends of the unit battery 12 in the axial direction.

The battery module 10 illustrated in FIG. 1 includes sixty unit batteries 12 that are arranged in a matrix with four rows and fifteen columns. The sixty unit batteries 12 in a four-by-fifteen matrix are separated at three locations in the longitudinal direction, which is the column direction or the X direction, and are divided into four battery groups. One battery group is composed of fifteen unit batteries 12, and the fifteen unit batteries 12 in the same battery group are connected in parallel by a positive electrode bus bar 23 and a negative electrode bus bar 25, which will be described below. Further, a battery group having fifteen unit batteries 12 connected in parallel is connected in series to another battery group or an external output terminal by an inter-group bus bar 26, which will be described below.

The unit batteries 12 are held in an upright position by a battery holder 14 in a state in which the positive electrode terminals are oriented in the same direction and the negative electrode terminals are oriented in the same direction. The phrase “held in an upright position” used herein only indicates that the unit batteries 12 are held in a state in which they are in a standing position with respect to the battery holder 14, irrespective of whether the unit batteries 12 are actually inclined at angles. Therefore, even if the battery module 10 is mounted in a vehicle in a horizontal orientation such that the center axes of the unit batteries 12 are substantially horizontal, the unit batteries 12 are considered to be “held in an upright position” if they are held by the battery holder 14 in a state in which their center axes are substantially perpendicular to the flat surface of the battery holder 14.

The battery holder 14 is a substantially flat plate component having a plurality of retention holes 15 formed therethrough. The unit batteries 12 are inserted into the retention holes 15, and are thus held in an upright position with the negative electrode terminals facing down (toward an exhaust cover 20). From another point of view, a coverage zone 66 (see FIG. 2) that is a portion of a unit battery 12 located near one end of the unit battery 12, the portion having a width in the axial direction, is housed in a retention hole 15. Further, the retention holes 15 pierce the battery holder 14 in the plate thickness direction, such that the lower ends of the unit batteries 12 and, in turn, the negative electrode terminals, are exposed downward.

The retention holes 15 have a round shape so as to fit over the circular column shape of the unit batteries 12. As the retention holes 15 have a slightly larger diameter than that of the unit batteries 12, a clearance is formed between the outer circumference of the coverage zone 66 of each unit battery 12 and the inner circumference of a corresponding retention hole 15. In the following description, the clearance formed between the outer circumferential surface of a coverage zone 66 and the inner circumferential surface of a retention hole 15 is referred to as “fit clearance 48.” An adhesive 46 is filled into the fit clearances 48, and the unit batteries 12 are fixed to the battery holder 14 by the adhesive 46.

The battery holder 14 is composed of a metal material having good heat transfer properties, for example, aluminum, in order to disperse produced heat uniformly to reduce variations in temperature between the unit batteries 12. However, the battery holder 14 is entirely coated with an insulating material in order to prevent electrical conduction with the unit batteries 12. The battery holder 14 may be coated with an insulating material by, for example, applying an insulating paint to the entire surface of the battery holder 14.

The plurality of unit batteries 12 that are held by the battery holder 14 are surrounded with a protective case 16. The protective case 16 is composed of an insulating resin and is shaped substantially like a box with the bottom being fully open. The lower end of the protective case 16 is fixed to the peripheral edge of the battery holder 14.

The protective case 16 has a top plate 30 (see FIG. 2) that is disposed near the upper end of the protective case 16, the top plate 30 pressing the positive electrode-side end surfaces of the unit batteries 12 toward the negative electrodes. The top plate 30 has an array of retention openings 32 having a smaller diameter than the outside diameter of the unit batteries 12. The positive electrode terminals 56 of the unit batteries 12 are exposed to the outside via the retention openings 32.

Inlet openings 34 (see FIG. 2) and outlet openings 36 (see FIG. 2) are formed in the surrounding wall of the protective case 16. The inlet openings 34 allow cooling air to flow into the inside of the battery module 10 for cooling the unit batteries 12. The outlet openings 36 allow the cooling air that has flowed into the inside of the battery module 10, to escape to the outside. The outlet openings 36 are formed in a side wall that is opposite to the inlet openings 34 with the plurality of unit batteries 12 being interposed between them. The inlet openings 34 and the outlet openings 36 are a plurality of slits formed in the side walls of the protective case 16.

The positive electrode bus bar 23 and the negative electrode bus bar 25 are disposed on opposite sides of the unit batteries 12 in the axial direction for electrically connecting either the positive electrode terminals or the negative electrode terminals of the unit batteries 12 with each other.

The positive electrode bus bar 23 includes four conductive plates 24 that are fastened to the top surface of the protective case 16. The four conductive plates 24 are fixed to the protective case 16 while being spaced apart from each other and being kept insulated from each other. Each of the conductive plates 24 electrically connects positive electrode terminals 56 of fifteen unit batteries 12 included in one battery group to each other. The conductive plates 24 have arrays of through holes 40, each through hole 40 corresponding to one of the unit batteries 12. Connection tabs 42 that are portions of the conductive plates 24 extend from the peripheral edges of the through holes 40. Each of the connection tabs 42 comes into contact with a corresponding positive electrode terminal, so that the positive electrode terminals of the unit batteries 12 in the same battery group are electrically connected.

The negative electrode bus bar 25 is an integral component in which four conductive plates 24 are molded with a resin 43. The conductive plates 24 of the negative electrode bus bar 25 have almost the same structure as that of the conductive plates 24 of the positive electrode bus bar 23, and have a plurality of through holes 40 and connection tabs 42 extending from the through holes 40. Each of the connection tabs 42 comes into contact with a corresponding negative electrode terminal, so that the negative electrode terminals of the unit batteries 12 in the same battery group are electrically connected.

The four battery groups are connected in series by the inter-group bus bar 26. Specifically, the inter-group bus bar 26 electrically connects a conductive plate 24 of the positive electrode bus bar 23 connected to one battery group and a conductive plate 24 of the negative electrode bus bar 25 connected to another adjacent battery group with each other. The inter-group bus bar 26 is a substantially flat plate component that is composed of an electrically conductive material such as copper, and is, as illustrated in FIGS. 1 and 2, disposed outside the protective case 16.

The exhaust cover 20 is disposed below the battery holder 14. The exhaust cover 20 is composed of metal such as aluminum, and is shaped by, for example, pressing. The peripheral edge of the exhaust cover 20 is hermetically sealed to the peripheral edge of the negative electrode bus bar 25 to form a hermetically sealed exhaust space 28 between the exhaust cover 20 and the battery holder 14. Gas emitted from the unit batteries 12 flows in the exhaust space 28.

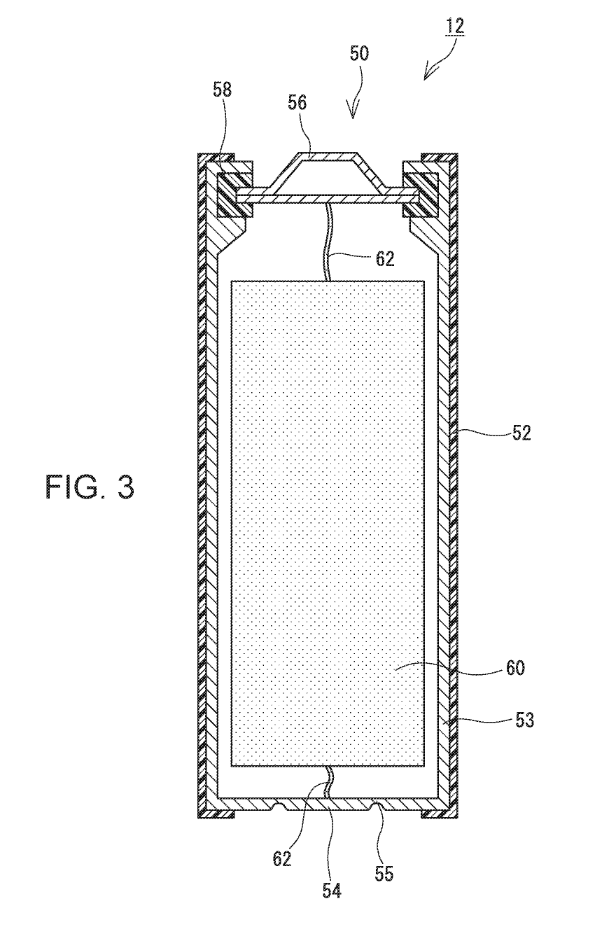

Next, the structure of the unit batteries 12 used in the battery module 10 will be described below with reference to FIG. 3. FIG. 3 schematically illustrates a structure of a unit battery 12. As illustrated in FIG. 3, the unit battery 12 includes a circular column-shaped battery body 50 and an insulating tube 52 that covers the outer periphery of the battery body 50. The battery body 50 includes a battery case 53, the positive electrode terminal 56, and a wound electrode assembly 60. The battery case 53 is a cylindrical container having a bottom wall and composed of an electrically conductive metal. The bottom wall of the battery case 53 serves as the negative electrode terminal 54 of the unit battery 12. Further, the bottom wall of the battery case 53 has a discharge valve 55 for allowing gas produced within the battery body 50 to escape. The discharge valve 55 may have any structure that can release an increased internal pressure of the battery body 50. The discharge valve 55 is formed by, for example, locally thinning the bottom wall of the battery case 53 such that it is ruptured under high pressure.

The upper end of the battery case 53 is open, and this opening has the positive electrode terminal 56 fitted therein with a gasket 58 being interposed between them. The positive electrode terminal 56 is composed of an electrically conductive metal and shaped substantially like a hat with its center protruding toward the outside. The gasket 58 is composed of an insulating and resilient material such as rubber, and electrically insulates the positive electrode terminal 56 and the negative electrode terminal 54 (the battery case 53) from each other.

The wound electrode assembly 60 and a liquid electrolyte are contained within the battery case 53. The wound electrode assembly 60 is formed by layering a sheet positive electrode, a sheet separator, and a sheet negative electrode and subsequently winding them into a scroll pattern. The wound electrode assembly 60 is contained in the battery case 53 in a state in which the winding axis is in parallel with the axis of the battery case 53. Further, the positive electrode and the negative electrode included in the wound electrode assembly 60 are respectively connected to the positive electrode terminal 56 and the negative electrode terminal 54 via a lead wire 62.

As can be clearly understood from the foregoing description, the battery case 53 is electrically continuous with the negative electrode terminal 54. As such, in order to insulate the outer periphery of the battery case 53, in this embodiment, the outer circumference of the battery body 50 is covered by the insulating tube 52. The insulating tube 52 is a tubular component composed of an insulating material such as polyethylene terephthalate (PET). The insulating tube 52 formed in this manner can be attached to the battery body 50 by, for example, shrinking (heat shrinking). Specifically, an insulating tube 52 having a larger diameter than that of the battery body 50 is formed using a heat-shrinkable insulating sheet, and this larger-diameter insulating tube 52 is fitted around the battery body 50. Then, by heating the entire insulating tube 52 in this state to cause heat shrinking, the insulating tube 52 adheres and is attached to the battery body 50. It should be noted that the method of attaching the insulating tube 52 described above is merely one example; the insulating tube 52 may be attached to the battery body 50 by any other method by which the insulating tube 52 can adhere around the battery body 50, such as by simply winding an insulating material. In any case, the insulating tube 52 is composed of an insulating material such as a resin, and even after being attached to the battery body 50, it shrinks in accordance with changes in temperature.

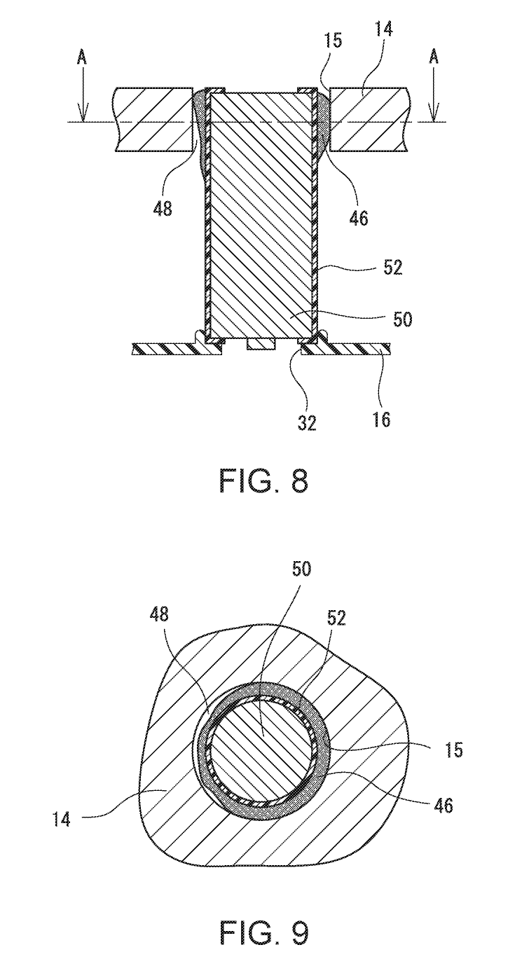

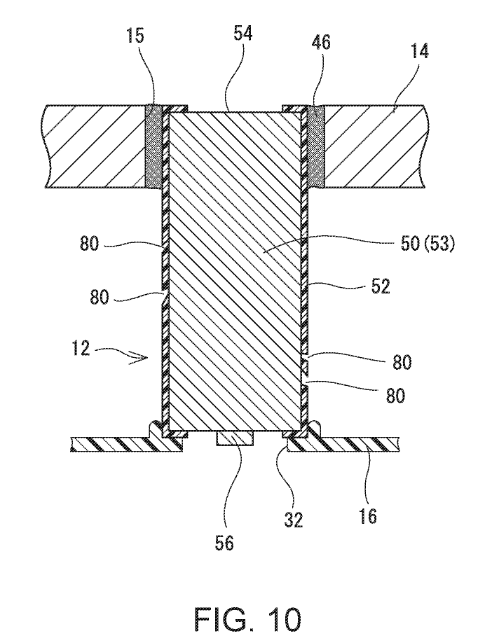

The unit batteries 12 formed as described above are inserted into the retention holes 15 of the battery holder 14 and are fixed by the adhesive 46. However, in a conventional battery module 10, as the inner circumferential surfaces of the retention holes 15 and the outer circumferential surfaces of the coverage zones 66 are smooth surfaces that are free from projections and depressions, it has been difficult to fill the adhesive 46 into the fit clearances 48 without any empty space. This will be further described below with reference to FIGS. 8 and 9. FIG. 8 illustrates a conventional manner in which bonding is performed, and FIG. 9 is a cross-sectional view taken along line A-A in FIG. 8.

To assemble the unit batteries 12 onto the battery holder 14, the operator, first, fixes the protective case 16 to the battery holder 14 and, subsequently, turns them upside down so that the battery holder 14 is above the protective case 16. Then, while the above-described state is being kept, as illustrated in FIG. 8, a unit battery 12 is inserted into a retention hole 15 of the battery holder 14, and the positive electrode-side end surface of the unit battery 12 is pressed against the protective case 16. In this state, the adhesive 46 is filled into the clearance (fit clearance 48) formed between the inner circumferential surface of the retention hole 15 and the outer circumferential surface of the coverage zone 66 of the unit battery 12.

In this process, in order to firmly and securely fix the unit battery 12 to the battery holder 14, it is desired that the adhesive 46 should be uniformly filled into the fit clearance 48 without any empty space. However, in conventional techniques, as the inner circumferential surface of the retention hole 15 and the outer circumferential surface of the coverage zone 66 are smooth surfaces that are free from projections and depressions, as illustrated in FIG. 8, the adhesive 46 is not kept within the fit clearance 48 and may drip down under the influence of gravity. As illustrated in FIG. 9, a shortage of the adhesive 46 will occur in some portions, and may result in insufficient fixing of the unit battery 12.

Such dripping of the adhesive 46 can be prevented simply by reducing the fit clearance 48 such that the adhesive 46 will be kept within the fit clearance 48 by the action of surface tension. However, if the fit clearance 48 becomes smaller, then, the adhesive 46 will not flow easily in the fit clearance 48 by the influence of surface tension. Then, as the adhesive 46 is not dispersed uniformly in the fit clearance 48, a shortage of the adhesive 46 will occur in some portions, and may result in insufficient fixing of the unit battery 12. In other words, in conventional techniques in which the inner circumferential surface of the retention hole 15 and the outer circumferential surface of the coverage zone 66 are smooth surfaces that are free from projections and depressions, it has been difficult to achieve both the prevention of the dripping of the adhesive 46 and the uniform dispersion of the adhesive 46, and, in turn, the failure of one or both may result in insufficient fixing of the unit battery 12.

In the illustrated embodiment, in order to prevent the above-described dripping of the adhesive 46 and, simultaneously, to disperse the adhesive 46 uniformly, an uneven surface 70 is formed on at least one of the inner circumferential surface of the retention hole 15 and the outer circumferential surface of the coverage zone 66. The uneven surface 70 includes at least one of a groove that extends in a direction that is not parallel to the axial direction, a rib that extends in a direction that is not parallel to the axial direction, and a group of projections and depressions consisting of projections and depressions that are dispersed uniformly on at least one of the inner circumferential surface of the retention hole 15 and the outer circumferential surface of the coverage zone 66.

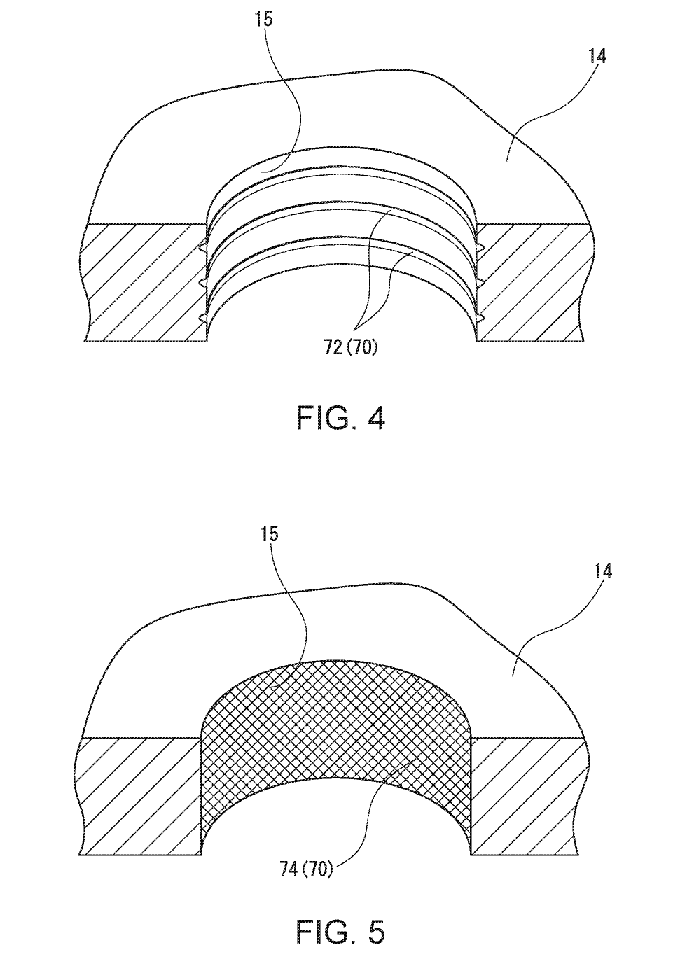

More specifically, as illustrated in FIG. 4, the uneven surface 70 may comprise a plurality of grooves 72 that are formed on the inner circumferential surface of the retention hole 15 and that extend in the circumferential direction. In this case, in preferred embodiments, the plurality of grooves 72 may be disposed such that they are spaced apart from each other in the axial direction. The spaces inside the grooves 72 in this structure serve as micro-passageways that extend in the circumferential direction. The grooves 72 have a depth and a width such that the micro-passageways formed thereby are of a size through which the adhesive 46 that is yet to be cured can be transferred in the circumferential direction by a capillary phenomenon.

Further, either in place of or in addition to the grooves 72 that extend in the circumferential direction, the uneven surface 70 may include a rib (not illustrated) that extends in the circumferential direction. In this case, in preferred embodiments, a plurality of ribs extending in the circumferential direction may be disposed such that they are spaced apart from each other in the axial direction. The ribs form micro-passageways that extend in the circumferential direction either between axially adjacent ribs or between a rib and the outer circumferential surface of the coverage zone 66 of the unit battery 12 that is opposed to the rib in the radial direction. The ribs have a height such that the micro-passageways formed thereby are of a size through which the adhesive 46 that is yet to be cured can be transferred in the circumferential direction by a capillary phenomenon.

In some embodiments, the grooves 72 or ribs that form micro-passageways extending in the circumferential direction are formed on the inner circumferential surface of the retention hole 15; in this case, some of the adhesive 46 is transferred through the micro-passageways in the circumferential direction by a capillary phenomenon. As such, in this case, even if the fit clearance 48 is narrowed so that the dripping of the adhesive 46 can be prevented, the adhesive 46 can be dispersed uniformly in the fit clearance 48. As a result, as both the prevention of the dripping of the adhesive 46 and the uniform dispersion of the adhesive 46 can be achieved, the unit battery 12 can be firmly and securely fastened to the battery holder 14.

The grooves or ribs that form the uneven surface 70 may extend in any direction that is not parallel to the axial direction, and do not have to extend exactly in the circumferential direction. The uneven surface 70, therefore, may include spirally extending grooves 72 or ribs.

The uneven surface 70 may include a group of projections and depressions consisting of projections and depressions that are dispersed uniformly on the inner circumferential surface of the retention hole 15. Specifically, as illustrated in FIG. 5, the uneven surface 70 may include, for example, a lattice pattern of projections and depressions 74 that are formed by knurling the inner circumferential surface of the retention hole 15, or a stipple pattern of projections and depressions (not illustrated) that are formed by embossing the inner circumferential surface of the retention hole 15. The lattice pattern of projections and depressions 74 or the stipple pattern of projections and depressions formed in this manner also forms micro-passageways through which the adhesive 46 is transferred by a capillary phenomenon. As a result, even if the fit clearance 48 is narrowed so that the dripping of the adhesive 46 can be prevented, the adhesive 46 can be dispersed uniformly in the fit clearance 48, and, in turn, the unit battery 12 can be firmly and securely fastened to the battery holder 14.

Although the examples described above are only those in which the uneven surface 70 is formed on the inner circumferential surface of the retention hole 15, the uneven surface 70 may be formed on the outer circumferential surface of the coverage zone 66 of the unit battery 12, either in place of or in addition to that formed on the retention hole 15. Specifically, for example, a groove that extends in a direction that is not parallel to the axial direction, a rib that extends in a direction that is not parallel to the axial direction, or a group of projections and depressions consisting of projections and depressions that are dispersed uniformly on the outer circumferential surface of the coverage zone 66 may be formed on the outer circumferential surface of the coverage zone 66 of the unit battery 12.

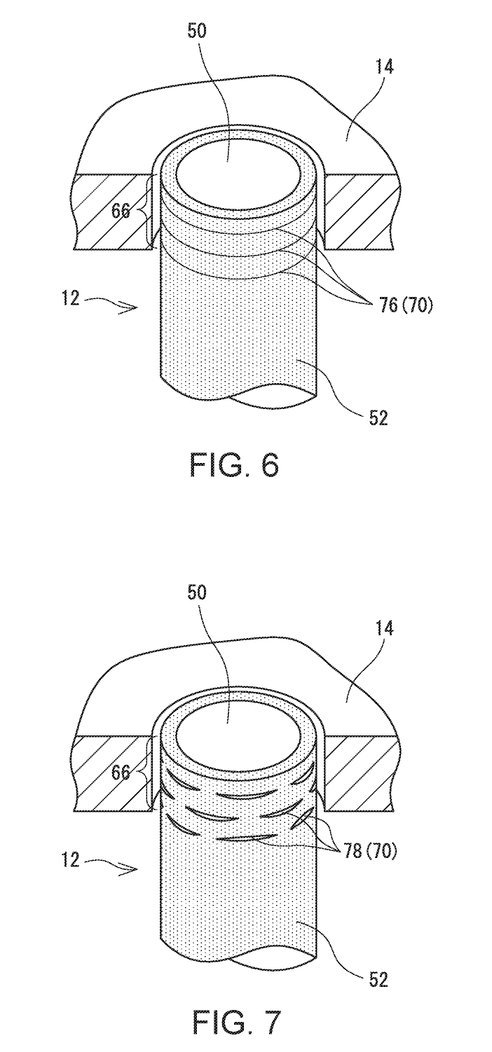

More specifically, in the illustrated embodiment, as the outer periphery of the unit battery 12 is covered by the insulating tube 52, if an uneven surface 70 is provided on the outer circumferential surface of the unit battery 12, the uneven surface 70 is formed on the insulating tube 52. In this structure, as will be described in detail below, in order to ensure the insulation of the battery body 50, in preferred embodiments, the uneven surface 70 may be formed only in a portion of the insulating tube 52 corresponding to the coverage zone 66. Therefore, as illustrated in FIG. 6, the uneven surface 70 may include grooves 76 that are formed only in a portion of the insulating tube 52 corresponding to the coverage zone 66 and extend in the circumferential direction. The grooves 76 are composed of half-cut lines that are cut to a depth of, for example, less than the thickness of the insulating tube 52.

As illustrated in FIG. 7, the uneven surface 70 may include a plurality of cuts 78 that are formed only in a portion of the insulating tube 52 corresponding to the coverage zone 66 and extend partially in the circumferential direction. It should be understood that, because a cut 78 extending all around in the circumferential direction would separate the insulating tube 52 in the axial direction, as illustrated in FIG. 7, the cuts 78 extend only partially in the circumferential direction. Further, in order to disperse the adhesive 46 uniformly, the cuts 78 are disposed such that they are dispersed uniformly in the circumferential direction.

Although not illustrated, the uneven surface 70 may include a plurality of wrinkles that are formed only in a portion of the insulating tube 52 corresponding to the coverage zone 66 and extend partially in the circumferential direction. Such wrinkles on the insulating tube 52 form a shape in which depressions and projections are successive in the axial direction, and the depressions and projections are a form of grooves and ribs, respectively. The wrinkles on the insulating tube 52 can be formed by, for example, locally heat shrinking the insulating tube 52. In the illustrated embodiment, by heating the entire insulating tube 52 at a predetermined shrink temperature for a predetermined shrink time to cause heat shrinking while the battery body 50 is being wrapped by the insulating tube 52, the insulating tube 52 adheres and is attached to the battery body 50. In this process, heat may be applied in a pattern of lines at a temperature higher than the shrink temperature or for a period of time longer than the shrink time only to a portion of the insulating tube 52 where wrinkles are to be formed; then, only this portion to which heat is applied in a pattern of lines shrinks more than the remaining portions so that wrinkles are formed. Also, rather than wrinkles, a group of projections and depressions may be formed by, for example, randomly heating and crimping a portion of the insulating tube 52 corresponding to the coverage zone 66.

When the uneven surface 70 (in the form of, for example, grooves 76, cuts 78, or wrinkles) is formed in this manner only in the portion of the insulating tube 52 corresponding to the coverage zone 66, similarly to the case where the uneven surface 70 is formed on the inner circumferential surface of the retention hole 15, the adhesive 46 that is yet to be cured can be kept within the fit clearance 48 in a state in which it is dispersed uniformly, and the unit battery 12 can be firmly and securely fastened to the battery holder 14. Forming the uneven surface 70 on the insulating tube 52 provides an additional merit in that it is possible to control where the insulating tube 52 deteriorates due to changes in temperature of the unit battery 12.

Typically, the temperature of the unit battery 12 varies significantly depending on the conditions in which the unit battery 12 is driven, or under the influence of outside air temperature. The insulating tube 52 that covers the outer periphery of the unit battery 12 continues to repeatedly expand and shrink due to the changes in temperature of the unit battery 12, even after it is attached to the battery body 50 by shrinking. The expansion and shrinkage will cause fatigue of the insulating tube 52, and as illustrated in FIG. 10, may result in unwanted cracks 80 in the insulating tube 52. If the uneven surface 70 is not formed on the insulating tube 52, cracks 80 are produced at random and uncontrollable portions. Therefore, as illustrated in FIG. 10, unwanted cracks 80 may be produced at portions located outside the coverage zone 66 (outside the battery holder 14), resulting in a problem in that the insulation of the unit battery 12 cannot be maintained.

In contrast, when the uneven surface 70 is formed only in the portion of the insulating tube 52 corresponding to the coverage zone 66, the expansion and shrinkage caused by heat shrinking tend to selectively occur prominently near the uneven surface 70. As a result, cracks 80 tend to be produced near the uneven surface 70, and it is unlikely that cracks 80 will be produced in the remaining portions. As the uneven surface 70 is formed only in the portion corresponding to the coverage zone 66, even if a crack 80 is produced in this portion, an area surrounding the crack 80 is covered by the adhesive 46 or the inner circumferential surface of the retention hole 15.

As described above, the battery holder 14 is entirely coated with an insulating material. Further, the adhesive 46 typically is composed of an insulating material such as a thermosetting resin. Therefore, even if cracks 80 are produced, as the battery case 53 composed of a conductive material is covered by an insulating material (the adhesive 46 or the inner circumferential surface of the retention hole 15) and is not exposed to the outside, the insulation of the unit battery 12 is ensured.

In other words, by forming the uneven surface 70 only in the portion of the insulating tube 52 corresponding to the coverage zone 66, it is possible not only to firmly and securely fix the unit battery 12 to the battery holder 14 as the dripping of the adhesive 46 is prevented, but also to more reliably ensure the insulation of the unit battery 12.

It should be noted that the configurations described above are mere examples; any configurations in which the uneven surface 70 including at least one of a groove that extends in a direction that is not parallel to the axial direction, a rib that extends in a direction that is not parallel to the axial direction, and a group of projections and depressions is formed on at least one of the outer circumferential surface of the coverage zone 66 of the column-shaped unit battery 12 and the inner circumferential surface of the retention hole 15 are possible with any desired modifications elsewhere. As such, for example, the unit battery 12 may have any column shape and may be rectangular column-shaped, rather than circular column-shaped. Further, if the battery case 53 of the unit battery 12 is, for example, composed of an insulating material or otherwise insulated from the negative electrode terminal 54 and the positive electrode terminal 56, the insulating tube 52 does not have to be provided.

1. A battery module comprising:
a plurality of column-shaped batteries;
a battery holder having a plurality of retention holes, each housing a coverage zone that is a portion of a corresponding one of the plurality of column-shaped batteries, the portion having a width in the axial direction of the column-shaped battery, the battery holder being configured to hold the plurality of column-shaped batteries in an upright position; and
an adhesive placed between an inner circumferential surface of each of the retention holes and an outer circumferential surface of a corresponding one of the coverage zones for fixing the column-shaped battery in the retention hole,
wherein at least one of the inner circumferential surface of the retention hole and the outer circumferential surface of the coverage zone has an uneven surface, and
wherein the uneven surface includes at least one of a groove that extends in a direction that is not parallel to the axial direction, a rib that extends in a direction that is not parallel to the axial direction, and a group of projections and depressions consisting of projections and depressions that are dispersed uniformly on at least one of the inner circumferential surface of the retention hole or the outer circumferential surface of the coverage zone.

2. The battery module according to claim 1, wherein the uneven surface includes a groove or a rib that extends in the circumferential direction.

3. The battery module according to claim 1,
wherein the column-shaped battery includes a column-shaped battery body and an insulator that covers the outer periphery of the battery body, the insulator being composed of an insulating material, and
wherein the uneven surface includes at least one of a groove, a cut, and a wrinkle formed only in a portion of the insulator corresponding to the coverage zone.

4. The battery module according to claim 2,
wherein the column-shaped battery includes a column-shaped battery body and an insulator that covers the outer periphery of the battery body, the insulator being composed of an insulating material, and
wherein the uneven surface includes at least one of a groove, a cut, and a wrinkle formed only in a portion of the insulator corresponding to the coverage zone.

5. The battery module according to claim 3, wherein the battery holder is entirely coated with an insulating material.

6. The battery module according to claim 4, wherein the battery holder is entirely coated with an insulating material.
